(19) United States
(12) Patent Application Publication
(10) Pub. No.: US 2009/0222391 A1
(43) Pub. Date: Sep. 3, 2009

(54) MANAGING AN ENCODER MALFUNCTION IN AN ELEVATOR DRIVE SYSTEM

(75) Inventors: Joseph G. Buda, Simsbury, CT (US); Anthony C. Black, South Windsor, CT (US); Michael J. Patria, Bristol, CT (US); Lisa A. Bongiovi, Suffield, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Otis Elevator Company, Farmington, CT (US)

(21) Appl. No.: 12/087,696

(22) PCT Filed: Feb. 7, 2006
(86) PCT No.: PCT/US06/04141

§ 371 Date: Nov. 3, 2008

(51) Int. Cl. G06N 5/00; G06F 17/30

(52) U.S. Cl. 706/45; 707/10; 707/104.1; 707/E17.01; 707/E17.044; 707/E17.005

(57) ABSTRACT

A knowledge base of information is generated to facilitate servicing of equipment from multiple manufacturers. A network (10) receives and publishes equipment servicing questions and answers from network users. Each equipment servicing question and associated answer submitted is validated and then stored in a searchable database (20).

### BACKGROUND OF THE INVENTION

The present invention relates to a dynamic knowledge base of information to facilitate servicing of equipment from multiple manufacturers.

Workers in the field of servicing equipment are often required to service equipment from multiple manufacturers. If a service worker is unfamiliar with the equipment from one of these manufacturers, he or she may contact other service workers who may be familiar with equipment from the manufacturer to determine how to best service the equipment. However, if the service worker is unable to locate someone with a solution, he or she may be unable to service the equipment. This results in a poor reputation for both the service worker and for the company employing the service worker. In addition, even if the service worker is able to find someone with a solution to his or her question, the likelihood that the same question may be asked and answered among several groups of service workers in the same company is high. The amount of time spent exchanging this type of information can be substantial, leading to inefficient use of time by the service workers.

### BRIEF SUMMARY OF THE INVENTION

The present invention is directed to generating a knowledge base of information to facilitate servicing of equipment from multiple manufacturers. A network receives and publishes equipment servicing questions and answers from network users. Each equipment servicing question and associated answer submitted is validated and then stored in a searchable database.

### BRIEF DESCRIPTION OF THE DRAWINGS

FIG. 1 is a block diagram of a system for generating and maintaining a knowledge base of information to facilitate servicing of equipment from multiple manufacturers.

FIG. 2 is a flow diagram of a process for generating a knowledge base of information to facilitate servicing of equipment from multiple manufacturers.

FIG. 3 is a screen shot of an interface to facilitate use of the knowledge base.

FIG. 4 is a flow diagram of a process for determining whether documents related to answers to equipment servicing questions may be posted in the knowledge base.

### DETAILED DESCRIPTION

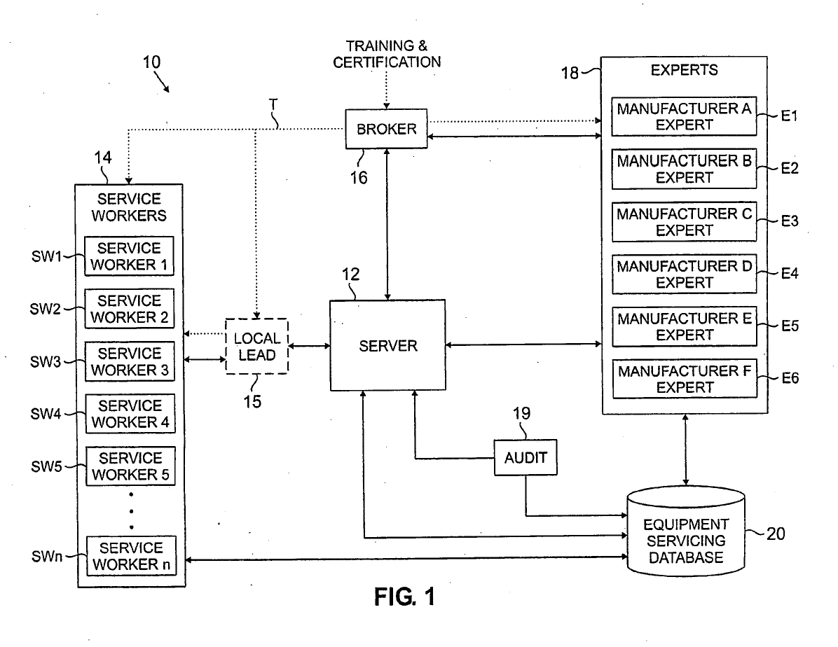

FIG. 1 is a block diagram of system 10 for generating and maintaining a knowledge base of information to facilitate servicing of equipment from multiple manufacturers. System 10 includes server 12, service worker block 14, local lead workstation 15, knowledge base network broker workstation 16, expert block 18, audit workstation 19, and equipment servicing database 20. Service worker block 14 includes a plurality of service workstations SW1, SW2, SW3, SW4, SW5, and SWn. Expert block 18 includes expert workstations E1, E2, E3, E4, E5, and E6. Service workstations SW1-SWn, expert workstations E1-E6, and broker workstation 16 are each connected to server 12. Server 12, service worker block 14, expert block 18, and audit workstation 19 are each connected to equipment servicing database 20.

System 10 connects individuals or users over a network to share knowledge and information about servicing of equipment, such as elevators, automobiles, airplanes, computers, industrial machines, appliances, and so on. In one embodiment, system 10 is a private network of employees of a company for sharing knowledge and information about servicing equipment from manufacturers other than the company. On the private network, only employees of the company (or a limited number of the employees) have access to the network. The information is stored in a knowledge base that functions as a dynamic electronic manual on how to service equipment from multiple manufacturers.

Server 12 is a network hub for exchanging information related to servicing of equipment between service worker block 14, local lead 15, network broker 16, expert block 18, and equipment servicing database 20. Server 12 receives equipment servicing questions, stores and organizes the equipment service questions and related answers for searching and review from service workstations SW1-SWn, local lead workstation 15, broker workstation 16, and expert workstations E1-E6.

Service workstations SW1-SWn are used by the service workers to communicate over the network with server 12 and equipment servicing database 20. Service workstations SW1-SWn may be any device capable of exchanging equipment servicing information with server 12, such as a personal computer or a personal digital assistant. In addition, service workstations SW1-SWn may include cellular telephones for communicating with the local lead 15 to exchange information over server 12. Service worker block 14 may include any number of service workstations n for use by a group of service workers. Service workers may include mechanics, field engineers, supervisors, adjusters, or any other individual associated with the servicing of equipment.

Local lead workstation 15 is used by a local lead who is a liaison between the service workers and the remainder of system 10. For clarity, only one local lead workstation 15 is shown, but system 10 typically includes multiple local lead workstations 15 for use by local leads dispersed worldwide to connect service workers in a region with the global network provided by system 10. The local lead trains and certifies service workers for using the network, and answers questions regarding the use of the network (e.g., posting of documents). The local lead also maintains a list of users and associated internet protocol (IP) addresses for their region. In addition, the local lead may translate information stored in server 12 to languages used in their region to facilitate exchange of information, or the local lead may translate questions provided by the service workers in their native language to a standard language for posting on server 12. Furthermore, the local lead may promote the use of the network by service workers in the local lead's region. The local lead may be a service worker trained to assist other service workers in using the network. Local lead workstation 15 is outlined in dashed lines because service worker block 14 may alternatively be connected directly to server 12.

Expert workstations E1-E6 are used by individuals who are knowledgeable (i.e., experts) about equipment from manufacturers other than the company maintaining system 10, and about servicing the equipment from the other manufacturers. Each of the experts validate equipment servicing questions and associated answers for information exchanges in their respective fields of expertise. In addition, the expert may provide answers to questions submitted by the service workers that are unanswered. In the embodiment shown in FIG. 1, experts on servicing of equipment from six manufacturers, Manufacturers A-F, use expert workstations E1-E6, respectively. Expert block 18 may include any number of expert workstations for use by equipment servicing experts from any number of manufacturers. In addition, expert block 18 may include multiple expert workstations for use by equipment servicing experts from the same manufacturer. The number of equipment servicing experts integrated into system 10 depends on the number of equipment manufacturers for which servicing information is stored in equipment servicing database 20. It should be noted that the groups of service workers and experts are not mutually exclusive, and an expert may be a service worker with extensive knowledge about equipment from a certain manufacturer.

Broker workstation 16 is used by a network broker to manage the information exchanged on system 10. In particular, the broker monitors interactions between the service workers and equipment manufacturer experts, reviews documents submitted by the service workers and the manufacturer experts in association with information exchanged through server 12, and indexes information verified for accuracy in equipment servicing database 20. In one embodiment, only the broker has the ability to post a document or image on the network. Thus, service workers and experts may send any documents to be posted to the broker for review and posting. Alternatively, if service workers and experts are properly trained as to all issues involved with posting documents, then service workers and experts may also post documents or images to the network directly.

System 10 may include more than one broker workstation 16 such that multiple network brokers may manage information exchanged on system 10. For example, brokers may be located globally and scheduled such that system 10 is managed more constantly over a 24-hour period. The network broker may consult with various other departments within the company (e.g., the intellectual property department) for guidance.

Audit workstation 19 is used by an auditor to review and audit the knowledge base stored in equipment servicing database 20 for compliance with all company guidelines for using the network. The auditor may also review the information stored in equipment servicing database 20 for accuracy, and to ensure that all intellectual property considerations related to the information have been addressed. Furthermore, the auditor may review equipment servicing questions and associated answers for compliance with all company guidelines for using the network. The auditor may be any employee or department of the company providing the network. In addition, while a single audit workstation 19 is shown, system 10 may include additional audit workstations 19.

Equipment servicing database 20 is an electronic storage medium in which equipment servicing questions that have been answered by a service worker or an expert and validated through a validation process are stored. The information stored in equipment servicing database 20 is accessible and searchable by the service workers, experts, and broker. For example, a graphical interface may be provided on service workstations SW1-SWn, expert workstations E1-E6, and broker workstation 16 that facilitates searching of the information stored in equipment servicing database 20.

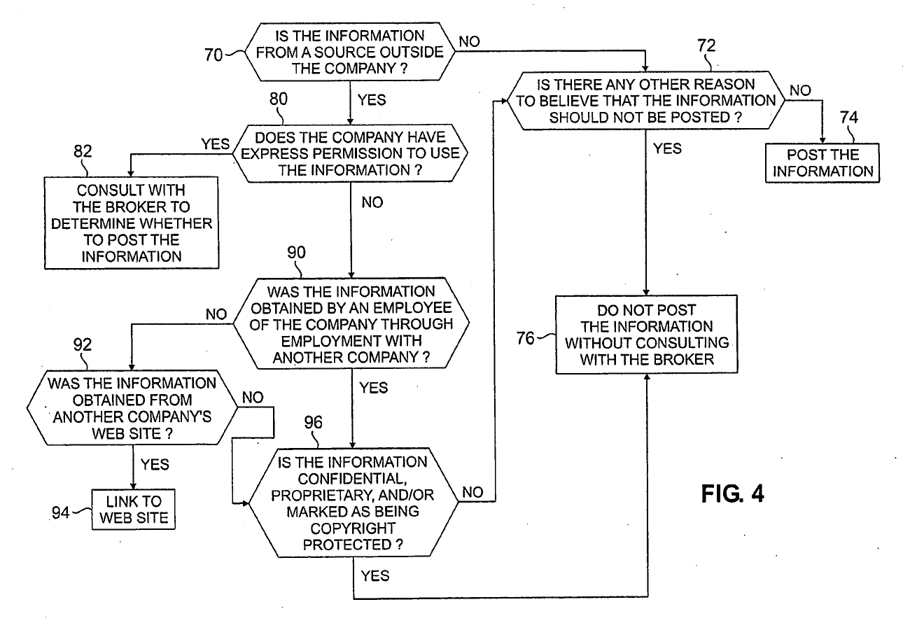

In order to access the network, all users of the network (i.e., the service workers, the experts, and the broker) are trained and certified, which may entail following certain company (e.g., corporate policy manual), network, and intellectual property guidelines when using the network. Training and certification tree T is shown in FIG. 1 with dotted lines. A network broker is trained and certified in all aspects of system 10, including exchanging of information and documents over the network, reviewing documents submitted for posting on the network with regard to intellectual property considerations (described in more detail with regard to FIG. 4), maintaining equipment servicing database 20, training local leads, service workers, and experts regarding the use of the network, and facilitating efficient and effective exchange of information between the service workers and experts. When a network broker is trained and certified, the network broker may assist in training and certification of additional network brokers.

The network broker assists in training and certifying of service workers, local leads, and experts. The network broker may either train and certify the service workers directly, or train and certify a local lead to train and certify service workers in the local lead's region. The network broker counsels the new users with regard to guidelines for using the network (e.g., company, network, and intellectual property considerations). The local leads, experts, and service workers are then familiarized with using the network by using a simulation network. The simulation network mirrors the actual network in terms of functionality to allow new users to become experienced with the process of exchanging information and documents over the network. When a user becomes experienced on the simulation network, the user signs a network use agreement, and the broker moves the user from the simulation network to the live network implemented by system 10. The broker maintains a list of all registered users, and updates the list as registered users leave the company.

After training and certification, the user is registered by server 12 as a member of the network. Registered users may then post, access, and search information stored in equipment servicing database 20. In particular, users may post questions, search posted questions, post answers to questions by other users, submit documents related to the answers, and search equipment servicing database for information related to servicing of equipment.

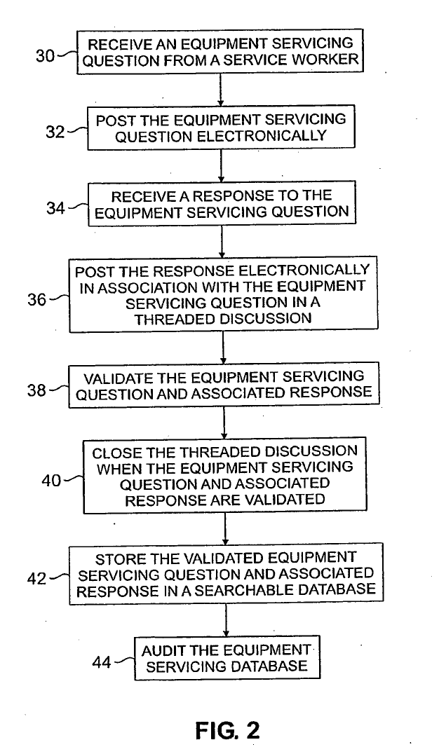

FIG. 2 is a flow diagram of a process used by system 10 for generating a knowledge base of information to facilitate servicing of equipment from multiple manufacturers. Server 12 receives an equipment servicing question from a service worker via one of service workstations SW1-SWn (step 30). For example, a service worker may be assigned to a job that requires knowledge of equipment from a manufacturer for which the service worker is unfamiliar, or that requires specialized expertise for which the service worker has not been trained.

Server 12 stores and electronically posts the equipment servicing question for viewing on service workstations SW1-SWn, broker workstation 16, and expert workstations E1-E6 (step 32). In other words, an equipment servicing question submitted by a service worker is published over the network for review by other service workers, the network broker, and the manufacturer experts. If the equipment servicing question was submitted in a foreign language, it may also be translated into a preferred language for each of the workstations prior to posting the question on the workstation. The network broker may review each posted equipment servicing question to assure that the question has not been previously answered, validated, and stored in equipment servicing database 20. In addition, the network broker may modify or delete any posted questions as necessary to assure accurate and efficient exchange of information. Furthermore, the network broker may facilitate the exchange of information by assuring the each question is answered in a timely manner, either by other service workers or by an equipment manufacturer expert.

Server 12 receives a response (i.e., a clarification question, an answer, or a solution) to the equipment servicing question from the service workers and the equipment manufacturer experts (step 34). The response may be accompanied by supporting documents, such as pictures, word processing documents, spreadsheets, presentations, or other such electronic documents. The network broker may require any submitted documents to satisfy intellectual property considerations before allowing the documentation to be made available over the network (see FIG. 4).

Server 12 then stores and electronically posts the response (and any approved supporting documents) in association with the equipment servicing question in the form of a threaded discussion (step 36). In this way, other service workers may review the submitted equipment servicing questions and associated responses, and also submit additional information or suggestions in response to the equipment servicing question. An expert may also provide a response to the equipment servicing questions. This results in a more complete solution to each of the equipment servicing questions, and may result in multiple alternative solutions to the same question.

When a response has been posted for an equipment servicing question, the network broker ensures that the question and associated response (which may be from one or multiple sources) are validated through a validation process (step 38). The validation process allows users of the network to ensure that the response provided to each equipment servicing question is accurate. For example, an expert may submit a solution to an equipment servicing question or may respond to a solution proposed by another expert or service worker (i.e., may agree or disagree with the proposed solution). In addition, a service worker may validate a solution by testing a proposed solution in the field and submitting a response related to the result of the test (i.e., whether the tested solution worked).

The network broker may also facilitate a quick response by forwarding the exchange to the expert that is knowledgeable about the equipment represented in the equipment servicing question and associated response. For example, if the equipment servicing question and associated response relate to equipment from Manufacturer B, the network broker sends the exchange to the Manufacturer B expert at expert workstation E2. The equipment manufacturer expert then reviews the exchange and provides an accurate solution for the equipment servicing question based on the responses provided by the service and the expert's own knowledge and experience. The expert may also request that certain proposed solutions be tested in the field by a service worker to validate the solution. Alternatively, if the network broker refers the equipment manufacturer expert to an equipment servicing question with no answer (for example, due to no responses posted to the question after a period of time), the expert may provide a solution based on his or her knowledge and experience, or on solutions tested in the field by a service worker.

After an equipment servicing question and associated response have been validated, the network broker closes the threaded discussion (step 40). At this point, no further responses may be posted to the equipment servicing question. The network broker then stores the validated equipment servicing question and associated response (and any supporting documents) in equipment servicing database 20, which is searchable by the service workers, experts, and broker (step 42). An interface may be provided on service workstations SW1-SWn, broker workstation 16, and expert workstations E1-E6 to facilitate searching of the information stored in equipment servicing database 20. In essence, system 10 allows the community of users (i.e., the network broker, service workers, local leads, and experts) to create a knowledge base of information on how to service equipment from various manufacturers.

The knowledge base of information stored in equipment servicing database 20 is continually audited to ensure that it is accurate and complete (step 44). For example, the network broker or auditor may continually review stored questions and corresponding answers and documents to assure that the information is stored and provided in an organized manner, that there is no redundancy between stored validated questions and solutions, and that the solution provided for each equipment servicing question is the best known solution for the issue presented. If a proposed solution is discovered to not be accurate, the network broker may update the closed threaded discussion to confirm that the proposed solution does not work. In addition, if alternative solutions to an equipment servicing question are discovered, the network broker may store all possible solutions in the knowledge base as acceptable solutions to the equipment servicing question.

The network broker or auditor may also review documents posted in association with validated questions and associated answers to assure that all intellectual property issues have been considered with regard to the documents (see FIG. 4), and to determine whether the documents may be associated with other validated questions and associated answers. In addition, the knowledge base may be audited by the network broker or auditor to ensure that information in the knowledge base is current and accurate, and that all intellectual property considerations have been addressed.

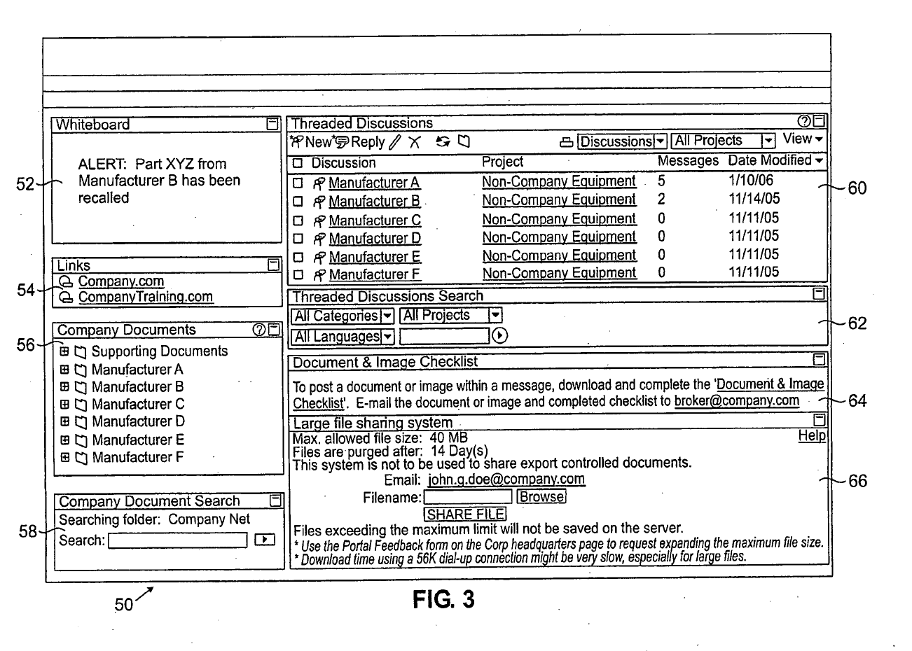

FIG. 3 is a screen shot of an example interface 50 that may be provided on the workstations for posting information to, and accessing and searching information in, the threaded discussions and equipment servicing database 20. Interface 50 includes whiteboard module 52, company-related link module 54, validated solutions module 56, validated solutions search module 58, threaded discussion module 60, threaded discussion search module 62, document posting checklist module 64, and supporting documents submission module 66. In interface 50, the company providing the network for equipment service information exchanging is referred to as “Company,” and the equipment manufacturers represented in the knowledge base are referred to as “Manufacturer A,” “Manufacturer B,” “Manufacturer C,” “Manufacturer D,” “Manufacturer E,” and “Manufacturer F.”

Whiteboard module 52 allows the network broker to post urgent or otherwise important messages for immediate review by the service workers. For example, as shown in FIG. 3, the whiteboard may be used to alert service workers of an equipment part being recalled by one of the manufacturers. In addition, whiteboard module 52 may be used to post information related to the operation of the network, such as a planned shutdown of the network for maintenance.

Company-related link module 54 includes hyperlinks to websites or other internet or intranet documents related to the company providing the network for exchange of equipment service information.

Validated solutions module 56 is an indexed directory of equipment servicing questions and associated solutions that have been validated by the validation process described above and stored by network broker 16 in equipment servicing database 20. The information is organized by the manufacturer represented in the equipment servicing questions and associated solutions, which may be accessed by expanding the electronic folder associated with the manufacturer. The information may be arranged by equipment model number or part number in the expandable folder, for example. In addition, documents approved by the network broker that support the validated solutions may be provided in a “Supporting Documents” expandable folder as shown in FIG. 3. Alternatively, the supporting documents may be made accessible in association with the validated solutions that they support (e.g., a link to the document provided with the validated solution).

Validated solutions search module 58 facilitates searching of equipment servicing questions and associated solutions that have been validated by the validation process and stored by the network broker in equipment servicing database 20. Validated solutions search module 58 may also be used to search the documents that support the validated solutions. The validated exchanges and associated documents may be searched by keyword, equipment model number, or by equipment part number, for example.

Threaded discussion module 60 is an indexed directory of equipment servicing questions that remain unanswered or for which answers have been provided but not closed by the network broker or validated by the validation process. The threaded discussion application in threaded discussion module 60 may be implemented by commercially available software integrated into the network. The threaded discussions are organized by the manufacturer represented in the equipment servicing questions. The threaded discussion for each manufacturer may be accessed by following the hyperlink associated with that manufacturer. In addition, using the pull-down menus at the top of threaded discussion module 60, the threaded discussions listed may be focused to those associated with one manufacturer (using the “Discussions” pull-down menu) or those associated with a particular project (using the “Projects” pull-down menu).

Threaded discussion search module 62 facilitates searching of equipment servicing questions that remain unanswered or for which answers have been provided but not closed by the network broker or validated by the validation process. The threaded discussion search application in threaded discussion module 60 may also be implemented by commercially available software integrated into the network. The threaded discussions may be searched globally, or the category, project, or discussion language of the search may be selected to provide a more focused search. The threaded discussions may be searched by keyword, equipment model number, or by equipment part number, for example.

Document posting checklist module 64 is used by a service worker to determine whether a supporting document for a solution to an equipment servicing question may be posted. In particular, the “Document & Image Checklist” hyperlink in document posting checklist module 64 opens a list of intellectual property requirements that the supporting document must satisfy in order to be posted in the threaded discussion or, once the associated solution is validated, stored in equipment servicing database 20. If the supporting document may be posted, supporting documents submission module 66 facilitates uploading of the document to server 12.

FIG. 4 is a flow diagram of a process for determining whether information submitted to the network may be posted within the network. The information includes any part of a threaded discussion, particularly the answers posted in response to equipment servicing questions. The information also includes any types of documents and images that may be posted on the network. All users of the network are trained with regard to the process shown in FIG. 4. The process flow may be provided for access and review by the users of the network (e.g., through the supporting documents folder in company documents module 56) to answer any questions related to information that may be posted on the network.

The first step in the process is to determine whether the information came from a source outside of the company providing the network (decision step 70). If the information was created or assembled by an employee of the company during employment with the company, then it is determined whether there is any other reason to believe that the information should not be posted (decision step 72). This is a catch-all step to assure that there are no intellectual property issues that could potentially arise from the posting. If there is no other reason to believe that the information should not be posted, then the information may be posted for accessing and searching in the threaded discussions or, after the associated equipment servicing question and solution are verified, in the equipment servicing database 20 (step 74). On the other hand, if there is any reason to believe that the information should not be posted, such as if portions of the information were assembled from sources outside of the company, then the information is not posted without consulting with the network broker (step 76).

If the information to be posted is from a source outside of the company, it is then determined whether the company has express permission to use the information (decision step 80). If the company has express permission to use the information (i.e., has permission directly from the outside source), the network broker is consulted to verify whether posting of the information is appropriate (step 82). This assures that the permission received from the outside source is sufficient enough to legally post all of the information contained in the submission.

If the company does not have express permission to use the information, it is then determined whether the information was obtained by an employee of the company through employment with another company (decision step 90). If the information was not obtained by an employee through employment with another company, then it is determined whether the information was obtained from another company's website (decision step 92). If the information was obtained from another company's website, then a link directing users of the network to the company's website (or the portion thereof containing the information) may be posted (step 94).

If the information was obtained by an employee of the company through employment with another company, or if the information was not obtained from another company's website, it is then determined whether the information is confidential, proprietary, and/or marked as being copyright protected (decision step 96). If the information is determined to be any of confidential, proprietary, or marked as copyright protected, then the information is not posted. The user may also consult with the network broker to determine whether his or her analysis with regard to posting the information is correct (step 76).

If the information is not confidential, proprietary, or marked as copyright protected, then it is determined whether there is any other reason to believe that the information should not be posted (decision step 72). If there is no other reason to believe that the information in should not be posted, then the information may be posted for accessing and searching in the threaded discussions or, after the associated equipment servicing question and solution are verified, in the equipment servicing database 20 (step 74). On the other hand, if there is any reason to believe that the information should not be posted, then the information is not posted. The user may also consult with the network broker to determine whether his or her analysis with regard to posting the information is correct (step 76).

When posting a document, the same process shown in FIG. 4 may be embodied in a document posting checklist. This checklist, which may be downloaded via document posting checklist module 64) is reviewed and executed by a service worker before submitting the document. The completed checklist is then submitted with the document to the network broker, who reviews the checklist and the document to determine whether the submitted document adheres to intellectual property guidelines before the document is posted on the network. The network broker determines whether the document submitted satisfies all intellectual property considerations and ultimately posts the document to the appropriate place on the network (e.g., in the threaded discussions or in equipment servicing database 20).

In summary, the present invention is directed to generating a knowledge base of information to facilitate servicing of equipment from multiple manufacturers. A network receives and publishes equipment servicing questions and answers from network users. Each equipment servicing question and associated answer submitted is validated and then stored in a searchable database. In essence, the knowledge base is a dynamic electronic manual on how to service equipment from multiple manufacturers. The manual is constantly updated, validated, and verified, which makes servicing of equipment from various companies more efficient and effective.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for generating a knowledge base of information to facilitate servicing of equipment from multiple manufacturers, the method comprising:
connecting users over a network operable to receive and publish equipment servicing questions and answers from the users;
validating the equipment servicing answers; and
storing each validated equipment servicing question and associated answer in a searchable database.

2. The method of claim 1, and further comprising:
providing an interface for the users to search the validated equipment servicing questions and associated answers in the searchable database.

3. The method of claim 2, wherein the storing step comprises:
arranging the validated equipment servicing questions and associated answers by manufacturer represented in the equipment servicing question.

4. The method of claim 1, wherein the equipment servicing questions and associated answers are provided in a threaded discussion.

5. The method of claim 1, and further comprising:
storing documents related to the answers in the searchable database.

6. The method of claim 1, and further comprising:
managing information submitted by users to the network.

7. The method of claim 6, wherein managing information submitted by users to the network comprises:
conducting an intellectual property clearance on the information to determine whether intellectual property rights of any of the multiple manufacturers would be violated by providing the information on the network; and
providing the information on the network if the intellectual property rights of the multiple manufacturers are not violated.

8. The method of claim 1, and further comprising:
translating the equipment servicing questions and associated answers to a language other than a published language.

9. The method of claim 1, and further comprising:
training users of the network regarding use of the network and exchange of information on the network prior to connection to the network.

10. The method of claim 1, and further comprising:
auditing the information in the knowledge base to ensure that the information is accurate and in compliance with network guidelines.

11. The method of claim 1, wherein the users include any of service workers, equipment manufacturer experts, and network brokers.

12. A method for sharing information between service workers of a first company connected over a network to facilitate servicing of equipment from companies other than the first company, the method comprising:
posting equipment servicing questions for equipment from the companies other than the first company for answering;
validating each answer provided to the equipment servicing questions; and
indexing each validated equipment servicing question and associated answer in a searchable database,
wherein an interface is provided to users of the network to search the validated equipment servicing questions and associated answers in the searchable database.

13. The method of claim 12, wherein the interface further allows the users to search the posted equipment servicing questions.

14. The method of claim 12, wherein the equipment servicing questions and associated answers are provided in a threaded discussion.

15. The method of claim 12, wherein the validating step comprises:
providing each equipment servicing question and associated answer submitted by the service workers to an expert for validation.

16. The method of claim 15, wherein the expert is employed by the first company and is knowledgeable about the equipment from one of the companies other than the first company that is represented in the equipment servicing question.

17. The method of claim 12, wherein the validating step comprises:
verifying an answer for accuracy by testing the answer on the equipment.

18. The method of claim 12, and further comprising:
storing documents related to the answers in the searchable database.

19. The method of claim 12, and further comprising:
managing information submitted by users to the network.

20. The method of claim 18, wherein storing documents comprises:
conducting an intellectual property clearance on the information to determine whether intellectual property rights of any of the companies other than the first company would be violated by providing the information on the network; and
providing the information on the network if the intellectual property rights of the companies other than the first company are not violated.

21. The method of claim 12, and further comprising:
translating the equipment servicing questions and associated answers to a language other than a posted language.

22. A system comprising:
a plurality of service workstations, each service workstation providing an interface to service workers of a first company to input equipment servicing questions regarding equipment from companies other than the first company;
a network server connected to each of the plurality of service workstations to provide the equipment servicing questions for answering by the service workers of the first company;
a plurality of expert workstations connected to the network server, each expert workstation providing an interface to experts employed by the first company to access and input equipment servicing questions and answers and to assist in validation of the equipment servicing questions and answers, wherein each expert workstation is associated with an expert knowledgeable about the equipment from at least one of the companies other than the first company;
a searchable database connected to the network server for storing validated equipment servicing questions and associated answers; and
a broker workstation connected to the network server for providing an interface to a broker to manage information submitted of the service workers and experts, and provide validated equipment servicing questions and associated answers in the searchable database.

23. The system of claim 22, wherein the interface on each of the service workstations further allows a service worker to search the validated equipment servicing questions and associated answers in the searchable database and to search the equipment servicing questions.

24. The system of claim 22, wherein the interface on each of the service workstations further allows the service workers to submit documents associated with answers to the equipment servicing questions.

25. The system of claim 24, wherein the broker further manages documents submitted by the service workers.

26. The system of claim 25, wherein the broker manages information submitted by service workers and experts by conducting an intellectual property clearance on the information to determine whether intellectual property rights of any of the companies other than the first company would be violated by providing the information on the network and providing the information on the network if the intellectual property rights of the companies other than the first company are not violated.

27. The system of claim 22, wherein the equipment servicing questions and associated answers are provided in a threaded discussion on the interface.

28. The system of claim 22, and further comprising:
a local lead workstation connected to the network server for use by a local lead to train and certify service workers for using the system, to answer questions from the service workers regarding use of the system, and to translate equipment servicing questions and associated answers to a language other than a submitted language.

29. The system of claim 22, and further comprising:
an audit workstation connected to at least one of the network server and the searchable database for reviewing information provided on the at least one of the network server and the searchable database for compliance with network use guidelines.

30. A method for maintaining a searchable database of information for use by service workers of a first company connected over a network to the searchable database to facilitate servicing of equipment from companies other than the first company, the method comprising:
monitoring equipment servicing questions received from the service workers regarding equipment from a company other than the first company;
monitoring answers provided to the equipment servicing questions and documents submitted in association with the answers;
providing each equipment servicing question and associated answer for validation to an expert on the equipment from the company other than the first company represented in the equipment servicing question; and
storing validated equipment servicing questions and associated answers and documents in the searchable database.

31. The method of claim 30, wherein monitoring equipment servicing questions comprises:
determining whether each received equipment servicing question is included in the validated equipment servicing questions and associated answers stored in the searchable database; and
deleting the received equipment servicing question if it is included in the validated equipment servicing questions and associated answers stored in the searchable database.

32. The method of claim 30, wherein monitoring documents submitted in association with the answers comprises:
conducting an intellectual property clearance on each document to determine whether intellectual property rights of any of the companies other than the first company would be violated by storing the document in the searchable database.

33. The method of claim 32, wherein conducting an intellectual property clearance on each document comprises:
determining whether the first company has express permission to use information contained in the document;
determining whether the information contained in the document was obtained by an employee of the first company through employment with any of the companies other than the first company;
determining whether the information contained in the document was obtained from a publication of any of the companies other than the first company; and
determining whether the information contained in the document is identified as confidential, proprietary, or copyrighted by a company other than the first company.

34. The method of claim 30, wherein the storing step comprises:
storing the documents if the intellectual property of the other companies is not violated.

35. The method of claim 30, wherein the storing step comprises:
indexing each validated equipment servicing question and associated answer and documents by the company other than the first company represented in the validated equipment servicing question.

36. The method of claim 30, and further comprising:
removing inaccurate or stale information from the searchable database.

37. A method for generating a knowledge base of information for use by service workers of a first company connected over a network to facilitate servicing of equipment from companies other than the first company, the method comprising:
receiving an equipment servicing question;
posting the equipment servicing question electronically;
receiving an answer to the equipment servicing question;
posting the answer electronically in association with the equipment servicing question in a threaded discussion;
receiving a response that validates the equipment servicing question and associated answer;
closing the threaded discussion when the equipment servicing question and associated response are validated; and
storing the validated equipment servicing question and associated response in a searchable database.

38. The method of claim 37, wherein an interface is provided for the service workers to search the validated equipment servicing questions and associated answers stored in the searchable database.

39. The method of claim 37, wherein the storing step comprises:
arranging the validated equipment servicing questions and associated answers by manufacturer represented in the equipment servicing question.

40. The method of claim 37, and further comprising:
storing documents related to the answers in the searchable database.
